(19) United States
(12) Patent Application Publication
(10) Pub. No.: US 2025/0096658 A1
(43) Pub. Date: Mar. 20, 2025

(54) METHOD FOR MANUFACTURING BRUSHLESS DC MOTOR

(71) Applicant: Raytheon Company, Waltham, MA (US)

(72) Inventor: Gary Joseph Sutton, Oro Valley, AZ (US)

(21) Appl. No.: 18/368,368

(22) Filed: Sep. 14, 2023

(51) Int. Cl. H02K 15/08; H02K 1/02; H02K 1/18; H02K 15/02; H02K 15/06

(52) U.S. Cl. CPC H02K 15/08; H02K 1/02; H02K 1/18; H02K 15/026; H02K 15/065; H02K 2213/03

(57) ABSTRACT

A method for making a brushless DC motor includes the steps of: applying coils to a plurality of teeth that extend radially outwardly from an inner ring; mounting an outer ring to radially outer ends of the plurality of teeth; and removing segments of the inner ring.

### BACKGROUND OF THE DISCLOSURE

The disclosure relates to electric motors generally, and to methods for making motors, particularly brushless DC motors.

Brushless DC motors are used in many applications. These motors, and many other types of motors as well, can be internally wound, or externally wound. Internal wound motors have a series of magnets mounted around the rotor, and coils mounted to the stator around the magnets of the rotor.

The coils or windings in such a structure are typically applied by winding around laminates or teeth that extend radially inwardly from an outside structure of the stator referred to as the back iron.

The need is increasing for increasingly smaller motors of this type. As the diameter of these devices gets smaller, however, the manufacture of the motor gets increasingly more difficult, especially when applying the windings to the inwardly extending teeth, where there is very little space to function either manually or with mechanical devices.

### SUMMARY OF THE DISCLOSURE

The disclosure relates to a method for making a brushless DC motor, and in one non-limiting embodiment, to a method for making an internally wound brushless DC motor. It will be appreciated that while the disclosure is made in terms of a brushless DC motor, the method disclosed herein can be useful in manufacture of other motors having similar structures, including but not limited to AC motors and/or brushed motors.

In one embodiment, a method for making a motor, comprises the steps of applying coils to at least one of a plurality of teeth that extend radially outwardly from an inner ring; mounting an outer ring to radially outer ends of the plurality of teeth; and removing segments of the inner ring.

In one non-limiting configuration, the motor is a brushless DC motor.

In another non-limiting configuration, the outer ring is mounted to the outer ends of the plurality of teeth with an interlocking mechanical structure.

In still another non-limiting configuration, the interlocking mechanical structure comprises a dovetail structure on one of the outer ring and the plurality of teeth, and a mating groove on the other of the outer ring and the plurality of teeth.

In a further non-limiting configuration, the removing step comprises removing a portion of the inner ring to create a plurality of gaps along the inner ring.

In a still further non-limiting configuration, the plurality of gaps are created in the inner ring in sections of the inner ring between radially inner ends of the plurality of teeth.

In another non-limiting configuration, the removing step comprises machining away the segments.

In still another non-limiting configuration, the removing step is carried out with a laser.

In a further non-limiting configuration, the applying step comprises machine winding the coils onto the plurality of teeth.

In a still further non-limiting configuration, the coils are prepared first and then slid onto the plurality of teeth.

In another non-limiting configuration, the applying step comprises manually winding the coils onto the plurality of teeth.

In still another non-limiting configuration, the removing step produces a final stator structure wherein the outer ring defines a back iron, with the plurality of teeth extending radially inwardly to T structures at radially inward ends, wherein the T structures are defined by remnants of the inner ring after the removing step, and further comprising positioning the final stator structure around a rotor.

In a further non-limiting configuration, the rotor further comprises a plurality of magnets that interact with coils on the plurality of teeth.

In a still further non-limiting configuration, the mounting step comprises sliding one of the outer ring and the plurality of teeth axially along an axis of the motor relative to the other of the outer ring and the plurality of teeth to engage the radially outer ends of the plurality of teeth with the outer ring.

In another non-limiting configuration, the inner ring and the outer ring comprise lamination grade steel.

In still another non-limiting configuration, the lamination grade steel is selected from the group consisting of silicon iron, cobalt iron and mixtures thereof.

In a further non-limiting configuration, the removing step defines a plurality of slots in the inner ring, extending along an axis of the motor.

In a still further non-limiting configuration, the slots have a width of between 0.005″ and 0.040″.

In another non-limiting configuration, the plurality of teeth comprises between 3 and 30 teeth.

In still another non-limiting configuration, the mounting step comprises a mechanical connection of the radially outer ends of the plurality of teeth and the outer ring.

In a further non-limiting configuration, the mounting step comprises an additional bonding step to bond the radially outer ends of the plurality of teeth with the outer ring.

Numerous features are disclosed in the various embodiments set forth herein. The features as disclosed can be combined in any combination, including partial features of any embodiment, unless specifically stated herein to the contrary.

### BRIEF DESCRIPTION OF THE DRAWINGS

A detailed description of preferred embodiments of the invention follows, with referenced to the attached drawings, wherein:

FIG. 1 illustrates an internally wound brushless DC motor;

FIG. 2 illustrates a starting point in the form of an inner ring with radially outwardly extending teeth for one embodiment of a method as disclosed herein;

FIG. 3 illustrates the structure of FIG. 2 with coils or windings applied to the teeth;

FIG. 4 illustrates an outer ring or back iron component to be applied to the structure of FIG. 3;

FIG. 5 illustrates the outer ring of FIG. 4 mounted to outer ends of the teeth of the structure of FIG. 3; and

FIG. 6 illustrates the final product with gaps removed from the inner ring.

### DETAILED DESCRIPTION

The present disclosure relates to motors and methods for manufacturing motors, for example brushless DC motors and, more particularly, to a method for making internally wound brushless DC motors which, in one embodiment, is especially useful for making such motors having small to very small diameters. As will be understood from a reading of the following disclosure, this method can be useful for manufacturing other motors including brushed and/or AC motors as well.

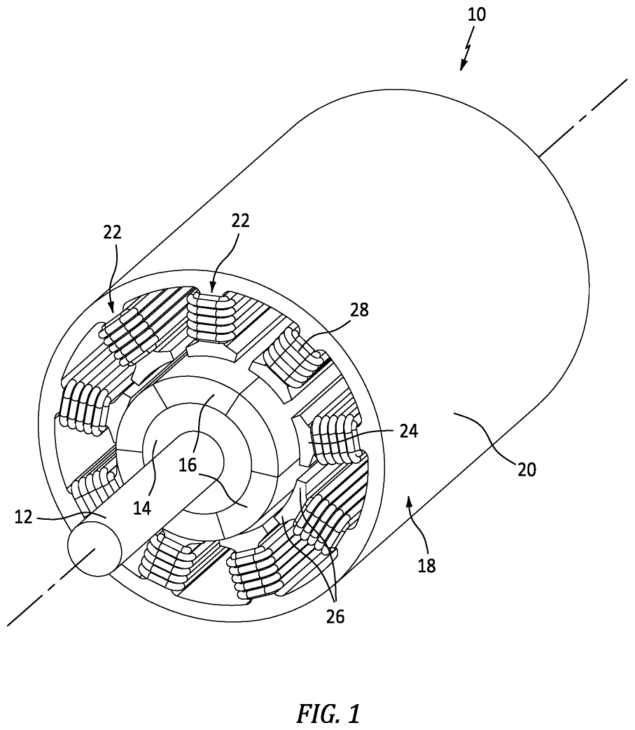

FIG. 1 illustrates an internally wound brushless DC motor 10. A motor shaft 12 carries a rotor 14 to which are mounted a series of magnets 16. A stator 18 is mounted around rotor 14 and magnets 16. Stator 18 is defined by an outer ring or back iron 20, and a plurality of inwardly extending teeth 22. An inwardly extending end 24 of each tooth 22 typically ends in T structure, or a widened or flanged area defined by laterally extending edges 26 which are spaced from magnets 16 by a small gap. Coils 28 are defined around teeth 22 and these coils are sequentially energized to drive the magnets and, thus, the rotor as is well known to persons of skill in the art.

In a motor such as motor 10, application of the coils to teeth 22 can become difficult for motors having smaller outside diameter. The most efficient manner of applying coils is to wind the coils by machine. However, as should be appreciated, when the motor is small, for example having an outside diameter of the outer ring 20 of less than about 1 inch, the space between ends of the inwardly extending teeth 22 is very small and it is problematic to access this area with machines, or manually, in order to apply the coils or windings to teeth 22.

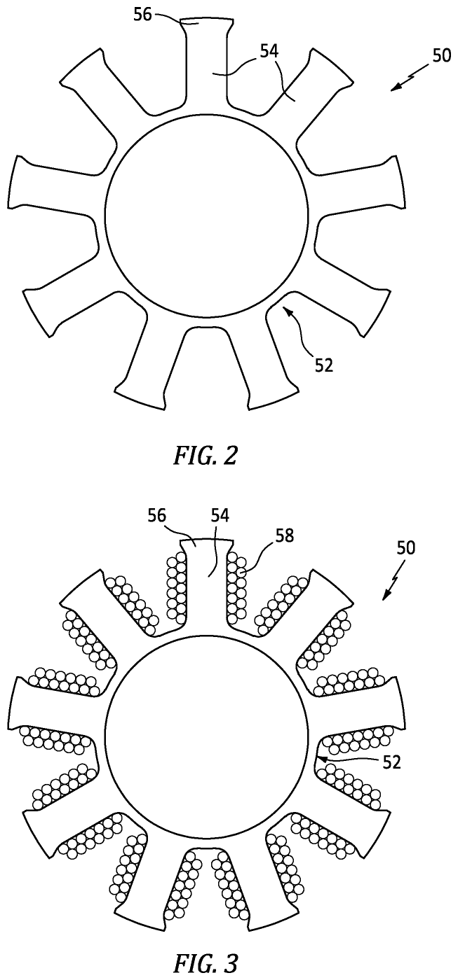

In one embodiment as disclosed herein, this problem is avoided by starting with an inner structure 50 (FIG. 2) which comprises an inner ring 52 having a plurality of radially outwardly extending teeth 54, each of which can end in a dovetail structure 56.

FIG. 3 shows this inner structure with coils 58 positioned on teeth 54 as desired. Because these coils 58 are being applied to radially outwardly extending teeth 54, there is much more room to access and apply the coils, either manually or by machine, even for motors having small size of, for example, less than 1 inch. Further, it should be noted that coils 58 can be wound onto teeth 54, or can be pre-formed and slid into place on teeth 54, as desired. Still further, it should be appreciated that coils can be applied to one, some or all of the teeth. Still further, it should be appreciated that the coils as disclosed herein can be simple coils around single teeth, for example linear winding, or could be applied as more complex windings such as but not limited to flyer winding, needle winding, toroidal core winding and any other winding method which would be known to a person skilled in the art. All such winding methods are within the scope of the present disclosure and method.

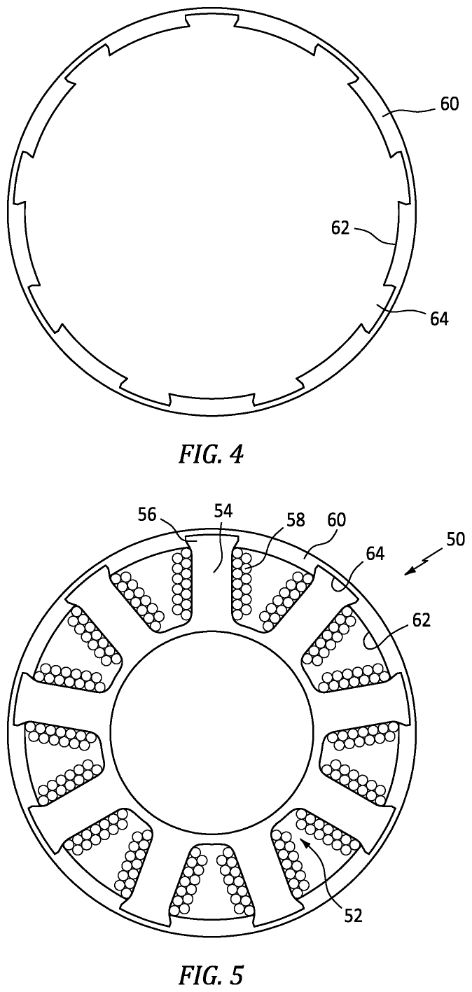

FIG. 4 shows an outer ring 60 for use as a back iron with the disclosed embodiment, and outer ring 60 is a solid ring having an inside surface 62 and a plurality of inwardly opening grooves or receptacles 64. Receptacles 64 are sized to firmly engage with dovetail structure 56 of teeth 54.

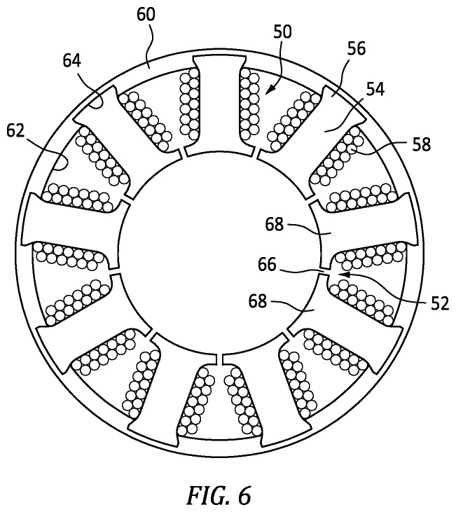

FIG. 5 shows outer ring 60 engaged with teeth 54 of inner ring 52, with receptacles 64 of outer ring 60 engaged with dovetail structures 56 of teeth 54. Outer ring 60 can be mounted in the position shown in FIG. 5 by sliding outer ring 60 into place with dovetail structures 56 engaged with receptacles 64. As shown in FIG. 1, the various rings and accompanying structures extend in a plane along the axis of rotation A of the rotor, and thus the dovetail structure 56 can be slid into receptacles 64 in a direction parallel to the axis of rotation A. Outer ring 60 can be held in place with respect to teeth 54 through mechanical engagement of dovetail structure 56 and receptacles 64 of teeth 54, or this connection can be further enhanced through bonding or other techniques to further secure dovetail structures 56 within receptacles 64 as needed or desired. This can be accomplished using a variety of bonding techniques.

Turning to FIG. 6, the next step of the method is to remove segments of inner ring 52 to form gaps 66 in the inner ring 52. This can be done without issue because teeth 54 are now firmly engaged in outer ring 60. Gaps 66 can be formed by machining (including but not limited to electrical discharge machining (EDM), or by numerous other manufacturing methods including laser etching and the like. Gaps 66 in one embodiment can be positioned between the radially inwardly extending ends 68 of teeth 54. This positioning of gaps 66 results in inwardly extending ends of teeth 54 that end in a T structure, that is, a structure wherein flanges extend along a circumference of the inner surface of the inner ring in opposite directions from the inwardly extending end of the teeth. Once gaps 66 are machined into inner ring 52, the stator structure is now complete and can be mounted around a rotor structure similar to that illustrated in FIG. 1.

In the embodiments illustrated in the drawings, the motor has nine (9) teeth 54, which are also referred to as laminates, and these teeth are separated by nine (9) gaps 66. It should be appreciated that the motor can be manufactured with any different number of teeth and gaps well within the scope of this disclosure.

As discussed above, outer ring 60 and the teeth 54 extending from the inner ring 52 are engaged in the step illustrated in FIG. 5 by engaging a dovetail structure 56 of teeth 54 with a receptacle 64 of outer ring 60. It should be appreciated that the focus is on a secure mechanical connection between these components, and therefore that other shapes and arrangements of components could be utilized well with the scope of this disclosure. For example, the receptacles and dovetail structures could be reversed, with the dovetail structures on the inner ring and the receptacles on the radially outward ends of the teeth. Further, mechanically interlocking structures of other shapes can also be utilized.

It should also be appreciated that the mechanical interlocking structure can in one non-limiting embodiment be provided with an interference or press fit to help ensure that the engagement of these structures is secure and rigid. Alternatively, or in addition, various adhesives or other securing materials can be applied to help hold the structures firmly together. Still further, if desired, end plates (not shown) can optionally be applied to the stator structure to secure teeth axially relative to the outer ring.

Outer ring 60 and inner ring 52 can be made from the same or different materials. Suitable materials include solid and/or lamination grade steels. Typical lamination grade steels include but are not limited to silicon iron and cobalt iron materials. In this regard, it should be noted that different lamination steels can be selected to further optimize the package size. Iron cobalt steel such as steel sold under the tradenames Hiperco and Vanadium Permendur could be used in a part that requires a higher flux density and then a traditional silicon steel could be used in areas of low density, for example. Soft magnetic composite materials can also be used for some or all of the components of the motor as disclosed herein. In addition, it may be desired to fabricate some or all components of the motor from solid steel, or in some instances the back iron or outer ring component can be fabricated from solid steel while the inner ring and teeth can be fabricated from laminate steel. Other combinations of materials may be suitable for specific environments, and all can be used well within the scope of the present disclosure.

Depending upon the materials, the inner ring structure and outer ring can be fabricated using any suitable method including but not limited to molding, casting, extrusion, additive manufacturing, machining or the like, and combinations of these methods, all as would be understood by a person having skill in the art.

FIG. 6 shows teeth 54 with radially outer ends engaged with outer ring 60 with the dovetail structure engaged in the receptacle. In situations where this mechanical connection is not made with a press or interference fit, it is a further option to bond or weld the materials together as mentioned above, for example using ultrasonic welding and similar techniques. Other bonding or welding techniques can also be used. In such an embodiment, it is possible that the teeth 54 will wind up as part of an integral structure with outer ring 60. In other instances, however, motors made according to the disclosed method will have a mechanical connection evident between the teeth and the outer ring.

The structure of the rotor and magnets can be as would be known to persons having ordinary skill in the art. In the disclosed embodiments, shaft 12 has rotor structure 14 with magnets 16 mounted around the outwardly facing surface of rotor structure 14. In the example shown in FIG. 1, there are 6 magnets having alternating polarity for interaction with the coils of the stator as is well known.

One or more embodiments of the present disclosure have been described. Nevertheless, it will be understood that various modifications may be made without departing from the spirit and scope of the disclosure as presented in the attached claims. Accordingly, other embodiments are within the scope of the following claims.

What is claimed is:

1. A method for making a motor, comprising the steps of:
applying coils to at least one of a plurality of teeth that extend radially outwardly from an inner ring;
mounting an outer ring to radially outer ends of the plurality of teeth; and
removing segments of the inner ring.

2. The method of claim 1, wherein the motor is a brushless DC motor.

3. The method of claim 1, wherein the outer ring is mounted to the outer ends of the plurality of teeth with an interlocking mechanical structure.

4. The method of claim 3, wherein the interlocking mechanical structure comprises a dovetail structure on one of the outer ring and the plurality of teeth, and a mating groove on the other of the outer ring and the plurality of teeth.

5. The method of claim 1, wherein the removing step comprises removing a portion of the inner ring to create a plurality of gaps along the inner ring.

6. The method of claim 5, wherein the plurality of gaps are created in the inner ring in sections of the inner ring between radially inner ends of the plurality of teeth.

7. The method of claim 1, wherein the removing step comprises machining away the segments.

8. The method of claim 1, wherein the removing step is carried out with a laser.

9. The method of claim 1, wherein the applying step comprises machine winding the coils onto the plurality of teeth.

10. The method of claim 1, wherein the coils are prepared first and then slid onto the plurality of teeth.

11. The method of claim 1, wherein the applying step comprises manually winding the coils onto the plurality of teeth.

12. The method of claim 1, wherein the removing step produces a final stator structure wherein the outer ring defines a back iron, with the plurality of teeth extending radially inwardly to T structures at radially inward ends, wherein the T structures are defined by remnants of the inner ring after the removing step, and further comprising positioning the final stator structure around a rotor.

13. The method of claim 12, wherein the rotor further comprises a plurality of magnets that interact with coils on the plurality of teeth.

14. The method of claim 1, wherein the mounting step comprises sliding one of the outer ring and the plurality of teeth axially along an axis of the motor relative to the other of the outer ring and the plurality of teeth to engage the radially outer ends of the plurality of teeth with the outer ring.

15. The method of claim 1, wherein the inner ring and the outer ring comprise lamination grade steel.

16. The method of claim 15, wherein the lamination grade steel is selected from the group consisting of silicon iron, cobalt iron and mixtures thereof.

17. The method of claim 1, wherein the removing step defines a plurality of slots in the inner ring, extending along an axis of the motor.

18. The method of claim 14, wherein the slots have a width of between 0.005″ and 0.040″.

19. The method of claim 1, wherein the plurality of teeth comprises between 3 and 30 teeth.

20. The method of claim 1, wherein the mounting step comprises a mechanical connection of the radially outer ends of the plurality of teeth and the outer ring.

21. The method of claim 1, wherein the mounting step comprises an additional bonding step to bond the radially outer ends of the plurality of teeth with the outer ring.
